(19) United States
(12) Patent Application Publication
(10) Pub. No.: US 2012/0215529 A1
(43) Pub. Date: Aug. 23, 2012

(54) Speech Enhancement

(75) Inventors: Nadir Cazi, Pune (IN); Thippur Venkatanarasaiah Sreenivas, Bangalore (IN)

(73) Assignee: INDIAN INSTITUTE OF SCIENCE, Karnataka (IN)

(21) Appl. No.: 13/503,257

(22) PCT Filed: Nov. 2, 2010
(86) PCT No.: PCT/IB10/54948

§ 371 Date: Apr. 20, 2012

(30) Foreign Application Priority Data
Apr. 30, 2010 (IN) 1226/CHE/2010

(51) Int. Cl. G10L 21/02; G10L 19/04

(52) U.S. Cl. 704/219; 704/227; 704/E21.002

(57) ABSTRACT

A method for processing and iteratively enhancing and estimating a source audio signal received at two audio receivers is provided. In one embodiment, the method involves the use of codebook constrained iterative binaural Wiener filter (CCIBWF). The provided CCIBWF embodiment can improve the quality of speech received at two audio receivers both in terms of noise reduction and speech intelligibility. In one embodiment, optimum speech enhancement performance was achieved within two iterations of the CCIBWF scheme. Further, the embodiment of the CCIBWF scheme introduces minimal distortion to the binaural cues, such as the interaural time delay cues, thereby preserving localization information of the audio source. The embodiment of the CCIBWF is also able to relatively accurately track the Time Delay of Arrival (TDOA) when the audio source is moving. This ensures that the performance of the CCIBWF scheme is not significantly degraded due to the selection of wrong codebooks.

### BACKGROUND

Unless otherwise indicated herein, the materials described in this section are not prior art to the claims in this application and are not admitted to be prior art by inclusion in this section.

Human computer interfaces nowadays often involve speech recognition, speech coding, and other forms of speech-based communications. Speech recognition capabilities have moved beyond medical and military applications into consumer electronics and general commercial use, such as voice dialing on cellular phones, data entry or database search term input, and speech-to-text word processing. There are a number of speech recognition algorithms that have been provided, including schemes based on the Hidden Markov model (HMM) and Dynamic time warping (DTW) concepts. Naturally, these schemes perform best when the input audio signal to be recognized is a generally clean signal.

However, the present disclosure recognizes that many speech-based communication applications may be operated in noisy environments such as public places, factory settings or air-traffic scenarios. The present disclosure presents techniques that may provide a reliable and robust performance in the presence of background noise. Accordingly, speech enhancement to reduce noise during pre-processing of a received speech signal is therefore relevant to the effectiveness of speech recognition in the subsequent processing.

### SUMMARY

In one embodiment, a method for enhanced processing of a source audio signal from an audio source is provided. The method comprises the operations of receiving the source audio signal from the audio source at a first audio receiver to generate a first audio signal; receiving the source audio signal from the audio source at a second audio receiver to generate a second audio signal; generating an enhanced audio signal from the source audio signal by evaluating the first audio signal and the second audio signal to identify variations between the first audio signal and the second audio signal; estimating a position of the audio source using the identified variations between the first audio signal and the second audio signal; and processing the first audio signal and the second audio signal according to the estimated position to generate the enhanced audio signal; and outputting the enhanced audio signal.

In a further embodiment, generating the enhanced audio signal may further comprise iteratively processing the first audio signal and the second audio signal with a two-channel Wiener filter, and providing a first estimated audio source signal and a second estimated audio source signal at each iteration. In one embodiment, the operation of generating the enhanced audio signal may further comprise reading a first codebook with a first vector quantizer, reading a second codebook with a second vector quantizer, and the Wiener filter iteratively receiving speech information from the first vector quantizer and the second vector quantizer. In one embodiment, generating the enhanced audio signal may further comprise iteratively performing linear prediction analysis on the first estimated audio source signal and the second estimated audio source signal. In one embodiment, estimating the position of the audio source using identified variations between the first audio signal and the second audio signal may further comprise acquiring the interaural time delays between the first audio receiver and the second audio receiver. In one embodiment, generating the enhanced audio signal may further comprise choosing the first codebook and the second codebook based on the estimated position of the audio source. In one embodiment the first codebook and the second codebook may be generated from a speech database, and wherein the source audio signal contains speech profiled in the speech database.

In an alternative embodiment, a system for enhanced processing of a source audio signal from an audio source is provided. The system comprises a first audio receiver configured to receive the source audio signal and generate a first audio signal; and a second audio receiver configured to receive the source audio signal and generate a second audio signal, a central system configured to iteratively evaluate the first audio signal and the second audio signal to identify variations between the first audio signal and the second audio signal, estimate a position of the audio source based on the identified variations, and process the first audio signal and the second audio signal according to the estimated position of the audio source to generate an enhanced audio signal.

In a further embodiment, the system may further comprise a two-channel Wiener filter configured to iteratively process the first audio signal and the second audio signal, and provide a first estimated audio source signal and a second estimated audio source signal at each iterative operation. In one embodiment, the Wiener filter may receive speech information from a first vector quantizer configured to read from a first codebook, and a second quantizer configured to read from a second codebook. In one embodiment, linear prediction analyses are performed on the first estimated audio source signal and the second estimated audio source signal at each iterative operation. In one embodiment, the variations between the first audio signal and the second audio signal may comprise interaural time delays between the first audio receiver and the second audio receiver. In one embodiment, the first codebook and the second codebook may be chosen based on the determined position of the source audio signal. In one embodiment, the first codebook and the second codebook are generated from a speech database, and the source audio signal contains speech profiled in the speech database.

In a further alternative embodiment, an article of manufacture including a non-transitory computer-readable medium having instructions stored thereon that is provided. The stored instructions, if executed by a computing device, may cause the computing device to perform operations comprising: receiving a first audio signal at a first audio receiver, wherein the first audio signal comprises a first signal component and a first noise component; receiving a second audio signal from a second audio receiver, wherein the second audio signal comprises a second signal component and a second noise component; generating an enhanced signal from the source audio signal according to the position of the audio signal the source audio signal by: evaluating the first audio signal and the second audio signal to identify variations between the first audio signal and the second audio signal; estimating a position of the audio signal using the identified variations between the first audio signal and the second audio signal; and processing the first audio signal and the second audio signal according to the estimated position to generate the enhanced audio signal; and outputting the enhanced audio signal; wherein the first signal component is a first portion of the source audio signal received by the first audio receiver, and the second signal component is a second portion of the source audio signal received by the second audio receiver.

In one embodiment, estimating the source audio signal may further comprise iteratively processing the first audio signal and the second audio signal with a two-channel Wiener filter, and providing a first estimated audio source signal and a second estimated audio source signal at iteration. In one embodiment, estimating the source audio signal may further comprise reading a first codebook with a first vector quantizer, reading a second codebook with a second vector quantizer, and the Wiener filter iteratively receiving speech information from the first vector quantizer and the second quantizer. In one embodiment, estimating the source audio signal may further comprise iteratively performing linear prediction analysis on the first estimated audio source signal and the second estimated audio source signal. In one embodiment, determining the position of the source audio signal using variations between the first audio signal and the second audio signal may further comprise acquiring the interaural time delays between the first audio receiver and the second audio receiver. In one embodiment, iteratively processing the first audio signal and the second audio signal may further comprise choosing the first codebook and the second codebook based on the determined position of the source audio signal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The embodiments will be further elucidated by means of the following description and the appended drawings.

FIG. 1 is a flow diagram showing an example method for iterative speech enhancement that is adapted in accordance with at least some embodiments described herein.

FIG. 2 is an illustrative example of the iterative speech enhancement method of FIG. 1 implemented in a diffuse noise environment in accordance with at least some embodiments described herein.

FIG. 3 is a block diagram showing an example scheme of a codebook constrained iterative binaural Wiener filter (CCIBWF) that is configured in accordance with at least some embodiments described herein.

FIG. 4 is a pair of plots of the SSNR and LLR against the cost function parameter μ, for an example CCIBWF scheme that is arranged in accordance with at least some embodiments described herein.

FIG. 5 is a graph of an example TDOA according to a simulation against the TDOA estimated by an example CCIBWF scheme that is arranged in accordance with at least some embodiments described herein.

FIG. 6 is an illustrative diagram of an example computing device arranged for processing and iteratively enhancing and estimating a source audio signal received at two audio receivers, in accordance with at least some embodiments described herein.

FIG. 7 is a schematic illustrating a partial view of an example computer program product that includes a computer program for executing a computer process on a computing device, arranged according to at least some embodiments presented herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

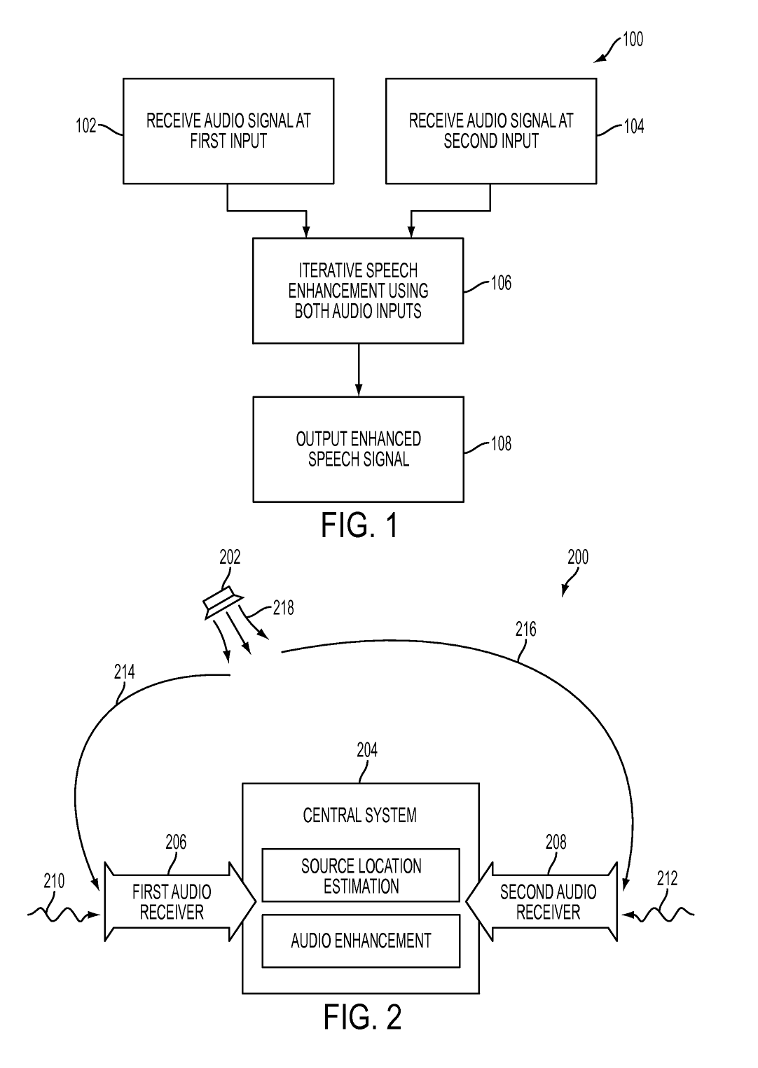

FIG. 1 is a flow diagram showing an example method 100 for iterative speech enhancement that is adapted in accordance with at least some embodiments described herein. Example method 100 may include one or more operations, functions, or actions as illustrated by one or more of blocks 102, 104, 106 and/or 108. Processing for method 100 may begin at block 102 and/or block 104. Block 102, “receive audio signal at first input,” and block 104, “receive audio signal at second input,” can be followed by block 106. Block 106, “iterative speech enhancement using both audio inputs” can be followed by block 108, “output enhanced speech signal.”

At block 102, an example apparatus can be configured for receiving an audio signal at a first audio receiver as a first audio signal. The received audio signal may be any of a variety of audio signals, such as speech or music. At block 104, the example apparatus can be configured for receiving the audio signal at a second audio receiver as a second audio signal. The audio signal may be provided from an audio source located at a specific position. Each of the audio receivers (i.e., the first and second audio receivers) can be located at a different spatial position. The difference in spatial positions results in each of the audio receivers generating different audio signals (i.e., first and second audio signals), each audio signal being a variation of the audio signal from the audio source. The variations from the audio signals are a function of the spatial differences of the first and second audio receivers.

At block 106, an example apparatus can be configured for estimating the source audio signal according to the position of the audio signal the first and second received audio signals are processed iteratively to enhance the received audio signals with the intention of estimating the source audio signal. At the output enhanced audio signal operation 108, the enhanced audio signal, enhanced via iterative processing is outputted for additional processing or other applications.

It should be appreciated that the blocks described herein may be implemented as a sequence of computer implemented instructions or program modules running on a computing device, as interconnected machine logic circuits or circuit modules, or some combination thereof. The implementation is a matter of choice dependent on the performance and other requirements of the various embodiments. Some of the logical operations described and illustrated by various blocks herein may be referred to as operating states, structural devices, modules, operations, functions or actions. These blocks may be implemented in software, firmware, general purpose logic or circuits, special purpose logic or circuits, or any combination thereof. It should also be appreciated that in some implementations one or more of the illustrated blocks may be eliminated, combined or separated into additional blocks than those shown in the figures and described herein. The various blocks may also be performed sequentially, in parallel, or in a different order than those described herein.

FIG. 2 is an example of a diffuse noise environment 200, wherein the iterative speech enhancement method 100 of FIG. 1 may be implemented in accordance with at least some embodiments described herein. The diffuse noise environment 200 includes an audio source 202, a central system 204, a first audio receiver 206, a second audio receiver 208, a first diffuse noise 210, a second diffuse noise 212, a first audio signal component 214, a second audio signal component 216, and an source audio signal 218. The first audio receiver 206 and the second audio receiver 208 are both coupled to the central system 204 and are each located a different position with respect to one another such that the receivers have spatial diversity. When a first audio signal component 214 and a second audio signal component 216 of a source audio signal 218 from the audio source 202 are transmitted to the first and second audio receivers respectively, the first audio receiver 206 and second audio receiver 208 each generate respective one of first and second audio signals. The first and second audio signals are both coupled to the central system 204 for processing. In one embodiment, central system 204 processing may include source location estimation and audio enhancement. Information on the spatial diversity between the receivers may further be used for source location estimation. In some embodiments, the first audio receiver 206 and the second audio receiver 208 are positioned on opposite sides of the central system 204. In various embodiments, the central system 204 may be configured to perform method 100 shown in FIG. 1. In additional embodiments, the central system 204 may be configured to transmit the first audio signal generated by the first audio receiver and the second audio signal generated by the second audio receiver to a remote location for iterative speech enhancement and/or further processing.

The first diffuse noise 210 and second diffuse noise 212 are noise signals in the environment. Diffuse noise is when the noise signals received at the two audio receivers come from multiple directions, with no particular dominant direction. The first diffuse noise 210 can represent the noise component of the source audio signal 218 received at the first audio receiver 206, and similarly, the second diffuse noise 212 can represent the noise component of the source audio signal 218 received at the second audio receiver 208. In some embodiments, the audio signal received at the first audio receiver 206 comprises a first audio signal component 214 of the source audio signal 218 and the first diffuse noise 210, while the audio signal received at the second audio receiver 208 comprises a second audio signal component 216 of the source audio signal 218 and the second diffuse noise 212. In some embodiments, the first diffuse noise 210 and the second diffuse noise 212 may originate from the audio source 202. In some other embodiments, part of the first diffuse noise 210 and part of the second diffuse noise 212 may originate from the audio source 202, while other portions of the diffuse noise may be from another source (e.g., from the environment). Further, the first diffuse noise 210 and the second diffuse noise 212 may be completely from sources other than the audio source 202.

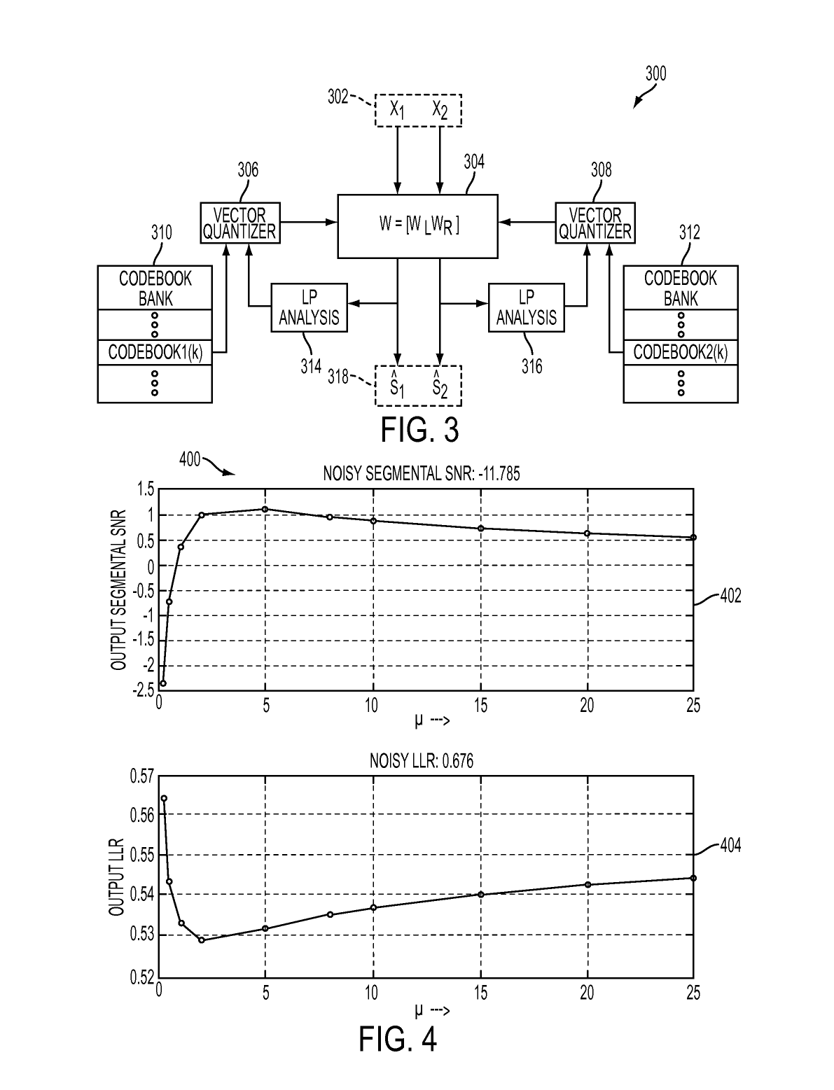

FIG. 3 is a block diagram of an example scheme 300 of a codebook constrained iterative binaural Wiener filter (CCIBWF) that is configured in accordance with at least some embodiments described herein. A Wiener filter can be configured to reduce the amount of noise present in a signal by comparing the input signal with an estimation of the desired noiseless signal. As such, the Wiener filter is not an adaptive filter and is instead based on a statistical approach. Further, the Wiener filter in this embodiment is an all-pole filter, defined by having a frequency response that have no zeros, and poles at specific frequencies The technique of iterative Wiener filtering as applicable to speech enhancement involves the sequential maximization of the a posteriori probability of the speech signal and its all-pole parameters. In addition, auditory motivated spectral constraints on the parameters may be implemented to improve the accuracy of the estimated signal. In an embodiment, auditory motivated spectral constraints may include an inter-frame constraint and an intra-frame constraint. Implementation of an inter-frame constraint on the filtering algorithm may ensure that speech spectral continuity is preserved in the estimated signal. Analogously, Implementation of an intra-frame constraint may ensure that the formant frequencies of speech signal are preserved in the estimate signal. The intra-frame constraint can be a vector quantizer (VQ) codebook utilizing redundancy between spectral parameters. As such, the outputs of a speech enhancement method using an iterative Wiener filtering technique may be constrained to belong to a codebook of clean speech spectra.

In some embodiments, the CCIBWF scheme 300 may be implemented within the central system 204 of FIG. 2, for performing the iterative speech enhancement operation 106 of FIG. 1. The CCIBWF scheme 300 comprises signal inputs 302, an optimum two-channel Wiener filter block 304, a first vector quantizer block 306, a second vector quantizer block 308, a first codebook 310, a second codebook 312, a first LP (linear prediction) analysis block 314, a second LP analysis block 316, and output signals 318. The signal inputs 302 are the signals received at the first and second audio receivers, the output signals 318 are the estimations of the clean signal from the audio source, which result from iterative signal processing as will be described below. The first code book 310 and second codebook 312 contain spectral information on the speech, within which the clean signal from the audio source is presumed to be. In some embodiments, one or more of the codebooks may contain line spectral frequency (LSF) vectors corresponding to the linear prediction coefficient (LPC) parameters of speech.

The Wiener filter block 304 is configured to: receive the signal inputs 302, receive outputs from the first vector quantizer block 306, receive outputs from the second vector quantizer block 308, and provide the output signals 318. The output signals 318 are coupled to the first LP analysis block 314 and second LP analysis block 316. Outputs from the first LP analysis block 314 are coupled to the first vector quantizer block 306, while outputs from the second LP analysis block 316 are coupled to the second vector quantizer block 308. The first vector quantizer 306 and second vector quantizers 308 are also configured to receive spectral information from the first codebook 310 and second codebook 312, respectively. As such, the Wiener filter 304, the vector quantizers 304 and 306, and the LP blocks 314 and 316 are cooperatively configured to form an iterative loop.

The signal inputs 302, which can be designated as X₁ and X₂, are the audio signals received from the first audio receiver 206, and the second audio receiver 208, respectively, X₁ and X₂ can be represented as follows:

$$[ \begin{matrix}{X}_{1} ( ω ) \\ {X}_{2} ( ω )\end{matrix} ] = [ \begin{matrix}{S}_{1} ( ω ) \\ {S}_{2} ( ω )\end{matrix} ] + [ \begin{matrix}{N}_{1} ( ω ) \\ {N}_{2} ( ω )\end{matrix} ] \qquad ( 1 )$$

S₁ and S₂ are the output signals 318 of the CCIBWF scheme 300, which are the theoretical clean source audio signal components from the audio source. N₁ and N₂ are the uncorrelated diffuse noise signals received at the first audio receiver 206 and the second audio receiver 208, respectively. Variable ω corresponds to frequency in radians/sec. In some embodiments, X₁, N₁ and S₁ are signals associated with the first audio receiver 206 (e.g., on a left side of the central system 204) and X₂, N₂ and S₂ are signals associated with the second audio receiver 208 (e.g., on the right side of the central system 204).

To solve for S₁ and S₂, weight vectors W_{L}(ω)=[W₁₁(ω)W₁₂(ω)]^{T} and W_{R}(ω)=[W₂₁(ω)W₂₂(ω)]^{T} for the left (L) and right (R) channels are determined such that a combined cost measure can be approximately minimized. For convenience, we define W^{H} as the weight vectors matrix of both the left and right channels such that W(ω)^{H}=[W_{L}(ω)^{H} W_{R}(ω)^{H}]. Further, as we also define X as the matrix for both input signals such that X(ω)=[X₁(ω)X₂(ω)]^{T}. As shown in equation 1, S(ω) and N(ω) are similar 2×1 vectors. In the frequency domain, each frequency component may be processed independently. Therefore, the explicit variable ω may be omitted when analyzing each frequency component separately. The weighted sum C of the residual noise energy and the speech distortion energy as a function of the weight vector W^{H} can then be provided as:

C(W^{H})=ε{(|S₁−W_{L}^{H}S|²+|S₂−W_{R}^{H}N|²)}+με{(|W_{L}^{H}N|²+|W_{R}^{H}N|²)} (2)

wherein ε denotes an energy value (as a function of corresponding vectors). Thus,

$$C ( {W}^{H} ) = ɛ \{ {‖ {S}^{T} - {W}^{H} [ \begin{matrix}S & {0}_{2 \times 1} \\ {0}_{2 \times 1} & S\end{matrix} ] ‖}^{2} \} + μ ɛ \{ ‖ {W}^{H} [ \begin{matrix}N & {0}_{2 \times 1} \\ {0}_{2 \times 1} & N\end{matrix} ] ‖ \} \qquad ( 3 )$$

By controlling the cost function parameter μ, different weights can be provided to the speech distortion and the residual noise, as a tradeoff between enhanced speech quality (signal-to-noise ratio, SNR) and intelligibility (log-likelihood ratio, LLR).

Assuming the speech signal to be uncorrelated with the noise in either channel and the noises in each channel being uncorrelated with each other, the minimized cost function

Wₒₚₜ, can be given as:

$$\begin{matrix}{W}_{opt} = {{[ \begin{matrix}{R}_{S} + μ {R}_{N} & 0 \\ 0 & {R}_{S} + μ {R}_{N}\end{matrix} ]}_{4 \times 4}^{- 1} [ \begin{matrix}{P}_{{S}_{1}} \\ {P}_{{S}_{21}} \\ {P}_{{S}_{12}} \\ {P}_{{S}_{2}}\end{matrix} ]}_{4 \times 1} \\ where , \\ \begin{matrix}{P}_{{S}_{1}} = ɛ \{ {S}_{1} {S}_{1}^{*} \} & {P}_{{S}_{21}} = ɛ \{ {S}_{2} {S}_{1}^{*} \} \\ {P}_{{S}_{12}} = ɛ \{ {S}_{1} {S}_{2}^{*} \} & {P}_{{S}_{2}} = ɛ \{ {S}_{2} {S}_{2}^{*} \} \\ {P}_{{N}_{1}} = ɛ \{ {N}_{1} {N}_{1}^{*} \} & {N}_{{N}_{2}} = ɛ \{ {N}_{2} {N}_{2}^{*} \}\end{matrix} \\ also & ( 4 ) \\ {R}_{S} = ɛ \{ {SS}^{*} \} = {[ \begin{matrix}{P}_{{S}_{1}} & {P}_{{S}_{12}} \\ {P}_{{S}_{21}} & {P}_{{S}_{2}}\end{matrix} ]}_{2 \times 2} \\ and & ( 5 ) \\ {R}_{N} = ɛ \{ {NN}^{*} \} = {[ \begin{matrix}{P}_{{N}_{1}} & 0 \\ 0 & {P}_{{N}_{2 }}\end{matrix} ]}_{2 \times 2} & ( 6 )\end{matrix}$$

P_{S}_{₁} and P_{S}_{₂} are poles of an all-pole Weiner filter that can be estimated from the codebook constrained iterative estimation of speech parameters for each channel. The estimate of P_{S}_{₁₂} may involve both phase and magnitude, wherein the magnitude equals \sqrt{P_{S}_{₁}P_{S}_{₁₂}}, and the phase equals the average of S₁S*₂ over a number of filter iterations. Since the first linear prediction analysis block 314 and second linear prediction analysis block 316 utilize a minimum phase models, P_{S}_{₁} and P_{S}_{₂} on the first codebook 310 and the second codebook 312, respectively), do not provide an exact phase difference between S₁ and S₂. Nevertheless, an averaging of the phase differences over several filter iterations is expected to capture the significant phase differences between the two channels. As such,
P_{S}_{₁₂}=\sqrt{P_{S}_{₁}P_{S}_{₂}}·e^{jφ}^{₁₂}=P*_{S}_{₂₁}, where φ is the significant phase difference between S₁ and S₂ acquired through averaging phase differences over a number of filter iterations. The estimated left channel signal Ŝ₁ can then be represented as:

$${\hat{S}}_{1} = {W}_{L}^{H} X = \frac{{H}_{1} ( 1 - {H}_{2} ) {X}_{1} + \sqrt{\frac{{P}_{{S}_{1}}}{{P}_{{S}_{2}}}} {e}^{{jφ}_{12}} \cdot {H}_{2} ( 1 - {H}_{1} ) {X}_{2}}{1 - {H}_{1} {H}_{2}} \\ given \\ {H}_{1} = \frac{{P}_{{S}_{1}}}{{P}_{{S}_{1}} + {P}_{{N}_{1 }}} \\ and \\ {H}_{2} = \frac{{P}_{{S}_{2}}}{{P}_{{S}_{2}} + {P}_{{N}_{2 }}} . \qquad ( 7 )$$

The estimated right channel signal Ŝ₂ can similarly be calculated.

As shown by equation 7, we can see that Ŝ₁ is dependent on both input channels, and H₁ and H₂ are directly dependent on the SNR of the both channels. If the SNR in one channel is much lower than that in the other channel, such that H2<<<H1 or H2<<1, then:

Ŝ₁≈H₁X₁,

given that (1−H₁H₂)≈1, H₂≈0, and (1−H₂)≈1. This is equivalent to the case of using a non-binaural, codebook constrained iterative Wiener filtering scheme on the left channel independently. Analogously, Ŝ₂ can be estimated as:

$${\hat{S}}_{2} = \sqrt{\frac{{P}_{{S}_{2}}}{{P}_{{S}_{1}}}} {e}^{- j {φ}_{12}} \cdot {H}_{1} {X}_{1} . \qquad ( 8 )$$

As such, the signal in the channel having a very low SNR is almost entirely estimated from the other channel with high a SNR.

For each iteration of the CCIBWF scheme 300 shown in FIG. 3 for the iterative speech enhancement method 100 of FIG. 1, Weiner filter all-pole parameters for each enhanced output of the linear prediction analysis blocks 314 and 316 are found, and vector quantizer codebooks 310 and 312 are searched for clean speech vectors with the least distortion. The codebook constrained all-pole parameters are then used to update the coefficients of the binaural Wiener filter W, for joint filtering leading to the subsequent iteration.

In some embodiments, different pairs of vector quantizer codebooks are designed according to the inter-aural time differences (ITD) between the two channels, which may be a function of the different azimuth angles at which the speech source is located about the central system 204, the first audio receiver 206 and the second audio receiver 208. The CCIBWF scheme 300 as shown in FIG. 3 uses the initial time delay of arrival (TDOA) to select the corresponding codebook pairs appropriate from the first codebook 310 and second codebook 312. Therefore, the observed ITD may be quantized such that the CCIBWF scheme 300 can choose an appropriate codebook from the finite set of codebooks.

In some scenarios, the source may not always be in the same direction throughout a conversation. As a result, the enhanced speech output 318 after each iteration may be used to estimate the gradually changing ITD of the moving audio source. In some embodiments, the ITD of a moving audio source can be calculated using cross-correlation between the audio signal received at the first audio receiver 206 and the audio signal received at the second audio receiver 208. As such, it is possible to track lateral position of the moving audio source up to a certain resolution the TDOA.

In one example implementation, speech data was obtained from an Indian Language Database (ILDB) at the Indian Institute of Science (IISc). Specifically, speech data amounting to thirty male and thirty female speakers, each providing about sixty seconds of speech, resulted in about 3600 seconds of speech, sampled at 8 kHz was obtained. Of these, ten speakers totaling 600 seconds of speech was reserved for testing and the remaining 3000 seconds of speech was used for training. The speech source was simulated to be positioned at different azimuth angles. The speech signals received at the first audio receiver 206 and the second audio receiver 208 was obtained by convolving the speech with a corresponding heat related transfer function of the central system 204 and the audio receivers. To simulate the diffuse noise environment, white Gaussian noise was added to the signals received at the first audio receiver 206 and the second audio receiver 208. In this example, the noise signals in the left and right channel are uncorrelated.

In this example, feature vectors of clean speech may be derived through linear prediction analysis of 20 ms frames. The audio source position may vary over a set of azimuth angles and the resulting binaural data may be used to design the bank of linear prediction parameter vector quantizer codebook pairs. For the purpose of codebook design, the TDOA may be quantized in sampling period increments such as 125 μs. In one embodiment, the TDOA ranges from −7 to +7 sampling period increments (−875 μs to +875 μs if sampling period is 125 μs), resulting in fifteen codebook pairs.

Table 1 compares the performance of an embodiment of a CCIBWF system against an embodiment of a CCIWF system for increasing number of iterations, and SNRs of −5 dB, 0 dB and +5dB. In these embodiments, the simulated speech source is positioned directly in front of the central system 204 and first and second audio receivers 206 and 208. In other words, the azimuth angle is 0 degrees. Since the first and second audio receivers 206 and 208 are symmetrically positions about the central system 204, the output signal from the input signal received at the first audio receiver 206 and the output signal from the input signal received at the second audio receiver 208 will be similar. As such, only results for audio signals received at the first audio receiver 206 are shown in Table 1.

TABLE 1

| | 5 dB | | 0 dB | | −5 dB | |
|---|---|---|---|---|---|---|
| | SSNR | | SSNR | | SSNR | |
| Speech Type | (dB) | LLR | (dB) | LLR | (dB) | LLR |
| Noisy | −6.801 | 0.521 | −11.784 | 0.676 | −16.770 | 0.814 |
| CCIWF (monaural) | 2.507 | 0.414 | 0.314 | 0.564 | −1.651 | 0.731 |
| CCIBWF | | | | | | |
| +1 iteration | 2.844 | 0.376 | 0.360 | 0.532 | −1.842 | 0.695 |
| +2 iteration | 3.183 | 0.371 | 0.721 | 0.527 | −1.639 | 0.693 |
| +3 iteration | 3.287 | 0.400 | 0.842 | 0.558 | −1.545 | 0.717 |
| +4 iteration | 3.322 | 0.423 | 0.873 | 0.580 | −1.513 | 0.734 |
| +6 iteration | 3.316 | 0.427 | 0.861 | 0.585 | −1.535 | 0.733 |

As shown in Table 1, this embodiment of the CCIBWF scheme shows a consistent improvement over monaural CCIWF for each of the SNR values, both in terms of the average segmental SNR (SSNR), as well as the average log likelihood ratio (LLR). As such, the additional information obtained from an additional channel is indeed beneficial for improving speech enhancement, given the bidirectional linear association between the speech components present in each channel. Note that for the CCIBWF scheme, the best noise performance is obtained with two iterations. In fact, as shown in Table 1, the performance decreases with additional iterations. As such, it appears that although the iterative binaural algorithm does not display a fast codebook convergence, optimal performance is achieved within a small number of iterations.

FIG. 4 is a pair of plots 400 of the SSNR and LLR against the cost function parameter μ for an example CCIBWF scheme that is arranged in accordance with at least some embodiments described herein. A first plot 402 illustrates the relationship between the SSNR and the cost function parameter μ, and a second plot 404 illustrates the relationship between the LLR and the cost function parameter μ. As shown by the noise performance, there is a trade-off between the speech distortion energy and the residual noise energy. In terms of both the SSNR and the LLR, both measures improve rapidly with increasing μ. In FIG. 4, we observe the noise performance as we vary the parameter μ, which provides a trade-off between the speech distortion energy and the residual noise energy. The performance in terms of both Avg. SNR and Avg. LLR improves rapidly with increasing μ, before reaching a maximum and reducing gradually. As shown in graphs 400 of FIG. 4, a suitable range for μ in some embodiments may be 2≦μ≦5, where the SSNR and LLR are comparatively consistent.

In some embodiments, binaural cues such as ITD and Interaural Level Difference (ILD) may be used for sound localization. An absolute ITD error metric may accordingly be used to evaluate the degradation of the localization information for the relevant enhancement algorithm embodiment. In other words, for a given audio source direction, the enhanced binaural output may be interpolated to a higher sampling frequency and calculate the ITD by cross-correlation, defining:

ITD Error=|ITD_{enhanced}−ITD_{clean}| (9)

averaged over a few seconds. In one embodiment, the interpolation to a higher sampling frequency may be by a factor of four. Table 2 shows the ITD error for an example CCIBWF over an azimuth angle range from 0° to 90°, in increments of 10°.

TABLE 2

| Azimuth (degrees) | ITD error (μs) |
|---|---|
| 0 | 15.2 |
| 10 | 24.5 |
| 20 | 36.6 |
| 30 | 22.7 |
| 40 | 17.9 |
| 50 | 16.2 |
| 60 | 66.9 |
| 70 | 107.4 |
| 80 | 37.5 |
| 90 | 38.3 |

As shown in Table 2, the embodiment of an example CCIBWF scheme can estimate the TDOA for a fixed source location direction within an absolute ITD error of less than 125 μs, which is one sample period for the example CCIBWF scheme. Also note that the ITD error for small azimuth angles (for example, less than ±40°) is less than 40 μs.

FIG. 5 is a graph 500 of an example TDOA according to a simulation against the TDOA estimated by an example CCIBWF scheme that is arranged in accordance with at least some embodiments described herein. For the simulation, the speech audio source is initially positioned directly in front of the central system 204, and then moved counter-clockwise around the central system 204 gradually over the course of ten seconds. As shown, the example CCIBWF scheme is able to track the TODA of the speech audio source sufficiently well, albeit with some tracking delay. In this example, the delay is a possible penalty of using long-term averaging to achieve better TDOA estimates.

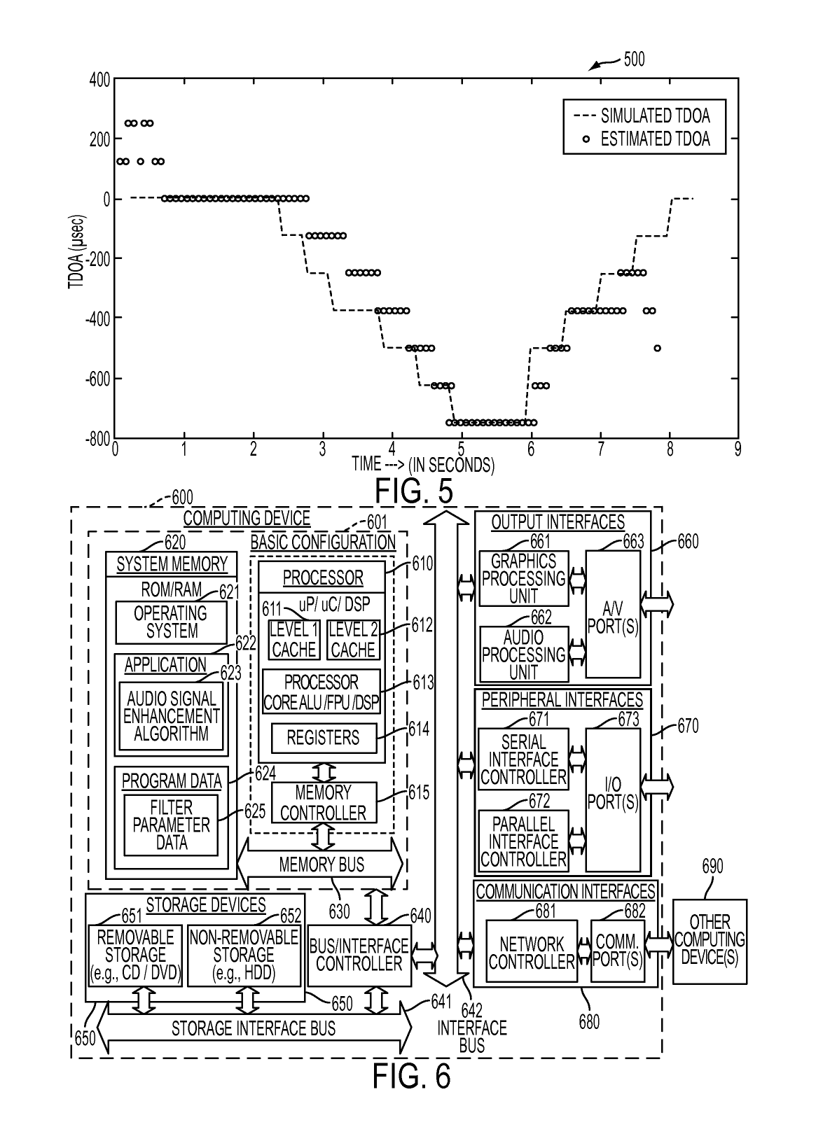

FIG. 6 is an illustrative diagram of an example computing device 600 arranged for processing and iteratively enhancing and estimating a source audio signal received at two audio receivers. In a very basic configuration 601, computing device 600 typically includes one or more processors 610 and system memory 620. A memory bus 630 can be used for communicating between the processor 610 and the system memory 620.

Depending on the desired configuration, processor 610 can be of any type including but not limited to a microprocessor (μP), a microcontroller (μC), a digital signal processor (DSP), or any combination thereof. Processor 610 can include one more levels of caching, such as a level one cache 611 and a level two cache 612, a processor core 613, and registers 614. The processor core 613 can include an arithmetic logic unit (ALU), a floating point unit (FPU), a digital signal processing core (DSP Core), or any combination thereof. A memory controller 615 can also be used with the processor 610, or in some implementations the memory controller 615 can be an internal part of the processor 610.

Depending on the desired configuration, the system memory 620 can be of any type including but not limited to volatile memory (such as RAM), non-volatile memory (such as ROM, flash memory, etc.) or any combination thereof. System memory 620 typically includes an operating system 621, one or more applications 622, and program data 624. Application 622 includes an audio signal enhancement algorithm 623 that is arranged for processing and iteratively enhancing and estimating a source audio signal received at two audio receivers. Program data 624 includes filter parameter data 625 that is useful for processing and iteratively enhancing and estimating a source audio signal received at two audio receivers, as will be further described below. In some example embodiments, application 622 can be arranged to operate with program data 624 on an operating system 621 such that the appropriate signal set rotations are implemented when processing and iteratively enhancing and estimating a source audio signal received at two audio receivers. This described basic configuration is illustrated in FIG. 6 by those components within dashed line 601.

Computing device 600 can have additional features or functionality, and additional interfaces to facilitate communications between the basic configuration 601 and any required devices and interfaces. For example, a bus/interface controller 640 can be used to facilitate communications between the basic configuration 601 and one or more data storage devices 650 via a storage interface bus 641. The data storage devices 650 can be removable storage devices 651, non-removable storage devices 652, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data.

System memory 620, removable storage 651 and non-removable storage 652 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media can be part of device 600.

Computing device 600 can also include an interface bus 642 for facilitating communication from various interface devices (e.g., output interfaces, peripheral interfaces, and communication interfaces) to the basic configuration 601 via the bus/interface controller 640. Example output interfaces 660 include a graphics processing unit 661 and an audio processing unit 662, which can be configured to communicate to various external devices such as a display or speakers via one or more A/V ports 663. Example peripheral interfaces 660 include a serial interface controller 671 or a parallel interface controller 672, which can be configured to communicate with external devices such as input devices (e.g., keyboard, mouse, pen, voice input device, touch input device, etc.) or other peripheral devices (e.g., printer, scanner, etc.) via one or more I/O ports 673. An example communication interface 680 includes a network controller 681, which can be arranged to facilitate communications with one or more other computing devices 690 over a network communication via one or more communication ports 682. The Communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 600 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 can also be implemented as a personal computer including both laptop computer and non-laptop computer configurations.

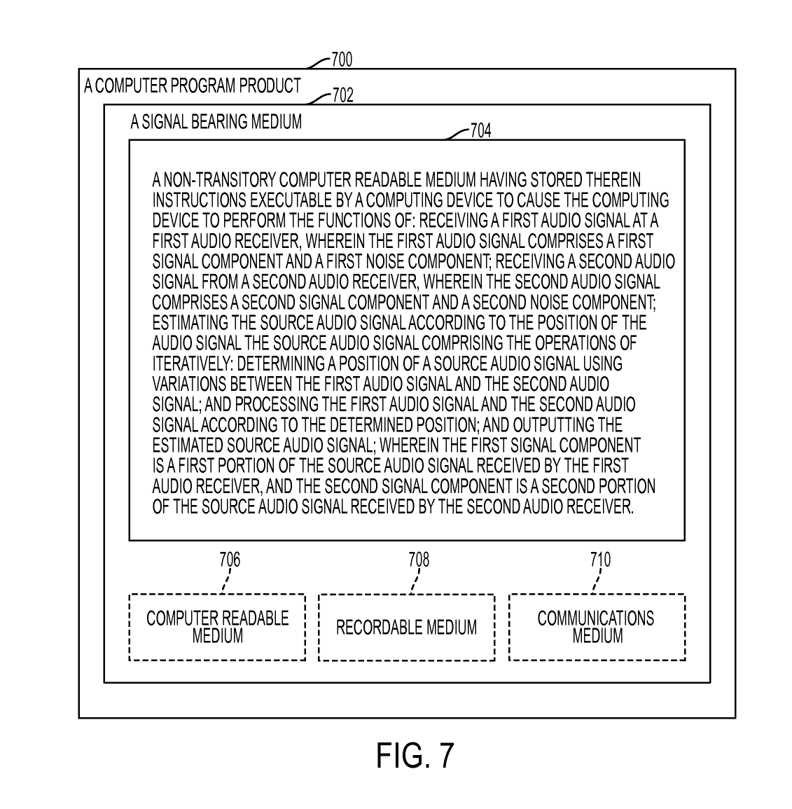

FIG. 7 is a schematic illustrating a partial view of an example computer program product that includes a computer program for executing a computer process on a computing device, arranged according to at least some embodiments presented herein. An illustrative embodiment of the example computer program product is provided using a signal bearing medium 702. Signal bearing medium 702 may include one or more instructions of 702.

The one or more instructions may be, for example, computer executable and/or logic implemented instructions. In some embodiments, the signal bearing medium 702 of the computer program product 700, a recordable medium 708, and/or a communications medium 710 may encompass a computer-readable medium 706, such as, but not limited to, a hard disk drive, a Compact Disc (CD), a Digital Video Disk (DVD), a digital tape, memory, etc. In some implementations, signal bearing medium 702 may encompass a recordable medium 708, such as, but not limited to, memory, read/write (R/W) CDs, R/W DVDs, etc. In some implementations, signal bearing medium 702 may encompass a communications medium 710, such as, but not limited to, a digital and/or an analog communication medium (e.g., a fiber optic cable, a waveguide, a wired communications link, a wireless communication link, etc.). Thus, for example, computer program product 700 may be conveyed to one or more modules of the described systems by an RF signal bearing medium 702, where the signal bearing medium 702 is conveyed by a wireless form of communications medium 710 a wireless communications medium conforming with the IEEE 802.11 standard).

In one embodiment, a method for enhanced processing of a source audio signal from an audio source is provided. The method comprises the operations of receiving the source audio signal from the audio source at a first audio receiver to generate a first audio signal; receiving the source audio signal from the audio source at a second audio receiver to generate a second audio signal; generating an enhanced audio signal from the source audio signal by: evaluating the first audio signal and the second audio signal to identify variations between the first audio signal and the second audio signal; estimating a position of the audio source using the identified variations between the first audio signal and the second audio signal; and processing the first audio signal and the second audio signal according to the estimated position to generate the enhanced audio signal; and outputting the enhanced audio signal.

In a further embodiment, generating the enhanced audio signal may further comprise iteratively processing the first audio signal and the second audio signal with a two-channel Wiener filter, and providing a first estimated audio source signal and a second estimated audio source signal at each iteration. In one embodiment, the operation of generating the enhanced audio signal may further comprise reading a first codebook with a first vector quantizer, reading a second codebook with a second vector quantizer, and the Wiener filter iteratively receiving speech information from the first vector quantizer and the second vector quantizer. In one embodiment, generating the enhanced audio signal may further comprise iteratively performing linear prediction analysis on the first estimated audio source signal and the second estimated audio source signal. In one embodiment, estimating the position of the audio source using identified variations between the first audio signal and the second audio signal may further comprise acquiring the interaural time delays between the first audio receiver and the second audio receiver. In one embodiment, generating the enhanced audio signal may further comprise choosing the first codebook and the second codebook based on the estimated position of the audio source. In one embodiment the first codebook and the second codebook may be generated from a speech database, and wherein the source audio signal contains speech profiled in the speech database.

In an alternative embodiment, a system for enhanced processing of a source audio signal from an audio source is provided. The system comprises a first audio receiver configured to receive the source audio signal and generate a first audio signal; and a second audio receiver configured to receive the source audio signal and generate a second audio signal, a central system configured to iteratively evaluate the first audio signal and the second audio signal to identify variations between the first audio signal and the second audio signal, estimate a position of the audio source based on the identified variations, and process the first audio signal and the second audio signal according to the estimated position of the audio source to generate an enhanced audio signal.

In a further embodiment, the system may further comprise a two-channel Wiener filter configured to iteratively process the first audio signal and the second audio signal, and provide a first estimated audio source signal and a second estimated audio source signal at each iterative operation. In one embodiment, the Wiener filter may receive speech information from a first vector quantizer configured to read from a first codebook, and a second quantizer configured to read from a second codebook. In one embodiment, linear prediction analyses are performed on the first estimated audio source signal and the second estimated audio source signal at each iterative operation. In one embodiment, the variations between the first audio signal and the second audio signal may comprise interaural time delays between the first audio receiver and the second audio receiver. In one embodiment, the first codebook and the second codebook may be chosen based on the determined position of the source audio signal. In one embodiment, the first codebook and the second codebook are generated from a speech database, and the source audio signal contains speech profiled in the speech database.

In a further alternative embodiment, an article of manufacture including a non-transitory computer-readable medium having instructions stored thereon that is provided. The stored instructions, if executed by a computing device, may cause the computing device to perform operations comprising: receiving a first audio signal at a first audio receiver, wherein the first audio signal comprises a first signal component and a first noise component; receiving a second audio signal from a second audio receiver, wherein the second audio signal comprises a second signal component and a second noise component; generating an enhanced signal from the source audio signal according to the position of the audio signal the source audio signal by: evaluating the first audio signal and the second audio signal to identify variations between the first audio signal and the second audio signal; estimating a position of the audio signal using the identified variations between the first audio signal and the second audio signal; and processing the first audio signal and the second audio signal according to the estimated position to generate the enhanced audio signal; and outputting the enhanced audio signal; wherein the first signal component is a first portion of the source audio signal received by the first audio receiver, and the second signal component is a second portion of the source audio signal received by the second audio receiver.

In one embodiment, estimating the source audio signal may further comprise iteratively processing the first audio signal and the second audio signal with a two-channel Wiener filter, and providing a first estimated audio source signal and a second estimated audio source signal at iteration. In one embodiment, estimating the source audio signal may further comprise reading a first codebook with a first vector quantizer, reading a second codebook with a second vector quantizer, and the Wiener filter iteratively receiving speech information from the first vector quantizer and the second quantizer. In one embodiment, estimating the source audio signal may further comprise iteratively performing linear prediction analysis on the first estimated audio source signal and the second estimated audio source signal. In one embodiment, determining the position of the source audio signal using variations between the first audio signal and the second audio signal may further comprise acquiring the interaural time delays between the first audio receiver and the second audio receiver. In one embodiment, iteratively processing the first audio signal and the second audio signal may further comprise choosing the first codebook and the second codebook based on the determined position of the source audio signal.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for enhanced processing of a source audio signal from an audio source, the method comprising:
receiving the source audio signal from the audio source at a first audio receiver to generate a first audio signal;
receiving the source audio signal from the audio source at a second audio receiver to generate a second audio signal;
generating an enhanced audio signal from the source audio signal by:
evaluating the first audio signal and the second audio signal to identify variations between the first audio signal and the second audio signal;
estimating a position of the audio source using the identified variations between the first audio signal and the second audio signal; and
processing the first audio signal and the second audio signal according to the estimated position to generate the enhanced audio signal; and
outputting the enhanced audio signal.

2. The method of claim 1, wherein generating the enhanced audio signal further comprises iteratively processing the first audio signal and the second audio signal with a two-channel Wiener filter, and providing a first estimated audio source signal and a second estimated audio source signal at each iteration.

3. The method of claim 2, wherein generating the enhanced audio signal further comprises reading a first codebook with a first vector quantizer, reading a second codebook with a second vector quantizer, and the Wiener filter iteratively receiving speech information from the first vector quantizer and the second vector quantizer.

4. The method of claim 3, wherein generating the enhanced audio signal further comprises iteratively performing linear prediction analysis on the first estimated audio source signal and the second estimated audio source signal.

5. The method of claim 1, wherein estimating the position of the audio source using identified variations between the first audio signal and the second audio signal further comprises acquiring the interaural time delays between the first audio receiver and the second audio receiver.

6. The method of claim 3, wherein generating the enhanced audio signal further comprises choosing the first codebook and the second codebook based on the estimated position of the audio source.

7. The method of claim 3, wherein the first codebook and the second codebook are generated from a speech database, and wherein the source audio signal contains speech profiled in the speech database.

8. A system for enhanced processing of a source audio signal from an audio source, the system comprising:
a first audio receiver configured to receive the source audio signal and generate a first audio signal; and
a second audio receiver configured to receive the source audio signal and generate a second audio signal,
a central system configured to iteratively evaluate the first audio signal and the second audio signal to identify variations between the first audio signal and the second audio signal, estimate a position of the audio source based on the identified variations, and process the first audio signal and the second audio signal according to the estimated position of the audio source to generate an enhanced audio signal.

9. The system of claim 8 further comprising a two-channel Wiener filter configured to iteratively process the first audio signal and the second audio signal, and provide a first estimated audio source signal and a second estimated audio source signal at each iterative operation.

10. The system of claim 9, wherein the Wiener filter receives speech information from a first vector quantizer configured to read from a first codebook, and a second quantizer configured to read from a second codebook.

11. The system of claim 10, wherein linear prediction analyses are performed on the first estimated audio source signal and the second estimated audio source signal at each iterative operation.

12. The system of claim 8, wherein the variations between the first audio signal and the second audio signal comprise interaural time delays between the first audio receiver and the second audio receiver.

13. The system of claim 10 where the first codebook and the second codebook are chosen based on the determined position of the source audio signal.

14. The system of claim 8, wherein the first codebook and the second codebook are generated from a speech database, and wherein the source audio signal contains speech profiled in the speech database.

15. An article of manufacture including a non-transitory computer-readable medium having instructions stored thereon that, if executed by a computing device, cause the computing device to perform operations comprising:
receiving a first audio signal at a first audio receiver, wherein the first audio signal comprises a first signal component and a first noise component;
receiving a second audio signal from a second audio receiver, wherein the second audio signal comprises a second signal component and a second noise component;
generating an enhanced signal from the source audio signal according to the position of the audio signal the source audio signal by:
evaluating the first audio signal and the second audio signal to identify variations between the first audio signal and the second audio signal;
estimating a position of the audio signal using the identified variations between the first audio signal and the second audio signal; and
processing the first audio signal and the second audio signal according to the estimated position to generate the enhanced audio signal; and
outputting the enhanced audio signal; wherein the first signal component is a first portion of the source audio signal received by the first audio receiver, and the second signal component is a second portion of the source audio signal received by the second audio receiver.

16. The article of manufacture of claim 15, wherein estimating the source audio signal further comprises iteratively processing the first audio signal and the second audio signal with a two-channel Wiener filter, and providing a first estimated audio source signal and a second estimated audio source signal at iteration.

17. The article of manufacture of claim 16, wherein estimating the source audio signal further comprises reading a first codebook with a first vector quantizer, reading a second codebook with a second vector quantizer, and the Wiener filter iteratively receiving speech information from the first vector quantizer and the second quantizer.

18. The article of manufacture of claim 17, wherein estimating the source audio signal further comprises iteratively performing linear prediction analysis on the first estimated audio source signal and the second estimated audio source signal.

19. The article of manufacture claim 15, wherein determining the position of the source audio signal using variations between the first audio signal and the second audio signal further comprises acquiring the interaural time delays between the first audio receiver and the second audio receiver.

20. The article of manufacture of claim 17, wherein iteratively processing the first audio signal and the second audio signal further comprises choosing the first codebook and the second codebook based on the determined position of the source audio signal.

21. A method for enhanced processing of a source audio signal from an audio source, the method comprising:
receiving the source audio signal from the audio source at a first audio receiver to generate a first audio signal;
receiving the source audio signal from the audio source at a second audio receiver to generate a second audio signal;
generating an enhanced audio signal from the source audio signal by iteratively:
evaluating the first audio signal and the second audio signal to identify variations between the first audio signal and the second audio signal;
estimating a position of the audio source using the identified variations between the first audio signal and the second audio signal and interaural time delays between the first audio receiver and the second audio receiver; and
processing the first audio signal and the second audio signal according to the estimated position to generate the enhanced audio signal; and
outputting the enhanced audio signal.

22. The method of claim 21, wherein processing the first audio signal and the second audio signal further comprises applying a two-channel Wiener filter to the first audio signal and the second audio signal to generate the enhanced audio signal.

23. The method of claim 22, wherein applying the two-channel Wiener filter further comprises:
receiving speech information from a first vector quantizer of a first codebook:
receiving speech information from a second vector quantizer of a second codebook; and
performing linear prediction analysis on the first audio signal using the first vector quantizer and on the second audio signal using the second vector quantizer.

24. The method of claim 23, wherein applying the two-channel Wiener filter further comprises reducing an amount of noise present in the source audio signal using an intra-frame constraint including information from the first codebook and the second codebook.

25. The method of claim 22, further comprising:
determining Weiner filter parameters for each of the first audio signal and the second audio signal;
searching a first vector quantizer codebook for a vector compared to the first audio signal with a least distortion resulting in an updated first audio signal;
searching a second vector quantizer codebook for a vector compared to the second audio signal with a least distortion resulting in an updated second audio signal; and
updating Wiener filter coefficients based on the Weiner filter parameters, the updated first audio signal, and the updated second audio signal.

26. The method of claim 25, wherein estimating the position of the audio source comprises estimating the interaural time delays between the first audio receiver and the second audio receiver using the updated first audio signal and the updated second audio signal after each iteration.

27. The method of claim 21, wherein processing the first audio signal and the second audio signal comprises:
using the interaural time delays between the first audio receiver and the second audio receiver to select corresponding codebook vector pairs from a first codebook and a second codebook; and
performing linear prediction analysis on the first audio signal using the codebook vector from the first codebook and on the second audio signal using the codebook vector from the second codebook.
